(19) United States
(12) Patent Application Publication
(10) Pub. No.: US 2019/0279298 A1
(43) Pub. Date: Sep. 12, 2019

(54) INFORMATION AUDITING METHOD, APPARATUS, ELECTRONIC DEVICE AND COMPUTER READABLE STORAGE MEDIUM

(71) Applicant: SIMPLECREDIT MICRO-LENDING COMPANY LIMITED, Chongqing (CN)

(72) Inventor: Kaining Wang, Chongqing (CN)

(21) Appl. No.: 16/422,419

(22) Filed: May 24, 2019

Related U.S. Application Data
(63) Continuation of application No. PCT/CN2018/084946, filed on Apr. 27, 2018.

(30) Foreign Application Priority Data
Jul. 24, 2017 (CN) 201710607336.8

(51) Int. Cl. G06Q 40/02; G10L 15/02; G10L 15/22

(52) U.S. Cl. CPC G06Q 40/025; G10L 2015/223; G10L 15/22; G10L 15/02

(57) ABSTRACT

The present disclosure provides an information auditing method, device, electronic device, and computer storage medium, and the method is applied to a voice loan system which enters load information in a voice way. The method comprises: in the process of entering the loan information by voice, recording reaction time duration of entering the target loan information, wherein the reaction time duration refers to a time interval from the completion of voice broadcast for promoting to enter the target loan information to the beginning of entering the target loan information; auditing the target loan information based on the reaction time duration; and determining a loan amount based on the entered loan information in the case that the auditing of the target loan information passes. In this way, the auditing accuracy of the loan information can be improved, and the credit risk of a credit platform can be reduced.

### CROSS REFERENCE TO RELATED APPLICATIONS

The present application is a continuation application of PCT Application No. PCT/CN2018/084946 filed on Apr. 27, 2018, which claims the priority of Chinese Patent Application No. 201710607336.8 filed on Jul. 24, 2017. The contents of all of the above are incorporated herein by reference in their entirety.

### FIELD OF THE INVENTION

The present disclosure relates to the field of information technology, and specifically, to an information auditing method, device, electronic device and computer readable storage medium.

### BACKGROUND OF THE INVENTION

In general, a credit platform needs to conduct risk assessment based on loan information provided by a lender, that is, verify the authenticity of the load information provided by the lender. At present, the loan information is generally audited by an external database or offline checking and other ways, and such auditing way is single and has relatively low efficiency.

### SUMMARY OF THE INVENTION

In view of this, the present disclosure aims at providing an information auditing method, device, electronic device and computer readable storage medium to improve the above problems.

In order to achieve the above object, an embodiment of the present disclosure provides an information auditing method applied to a voice loan system, the voice loan system enters loan information in a voice way, and the method comprises:

in the process of entering the loan information by voice, recording reaction time duration of entering target loan information, wherein the reaction time duration refers to a time interval from the completion of voice broadcast for promoting to enter the target loan information to the beginning of entering the target loan information; auditing the target loan information based on the reaction time duration; and

determining a loan amount based on the entered loan information in the case that the auditing of the target loan information passes.

An embodiment of the present disclosure further provides an information auditing device applied to a voice loan system, the voice loan system enters loan information in a voice way, and the device comprises:

a recording module for recording reaction time duration of entering target loan information in the process of entering the loan information by voice, wherein the reaction time duration refers to a time interval from the completion of voice broadcast for promoting to enter the target loan information to the beginning of entering the target loan information;

a first auditing module for auditing the target loan information based on the reaction time duration; and

a first processing module for determining a loan amount based on the entered loan information in the case that the auditing of the target loan information passes.

An embodiment of the present disclosure further provides an electronic device, the electronic device comprises a memory and a processor, the memory is used for storing computer program codes, and the processor is used for executing the computer program codes stored in the memory to implement the information auditing method.

An embodiment of the present disclosure further provides a computer storage medium with a computer program stored thereon, and the computer program implements the information auditing method when being executed by the processor.

The information auditing method, device, electronic device and computer readable storage medium provided by the embodiments of the present disclosure are applied to the voice loan system. The target loan information is audited according to the reaction time duration of entering the target loan information by a user in the voice loan system to determine the credibility of the target loan information. In the case that the auditing of the target loan information passes, a loan amount is further determined on the basis on the entered loan information. In this way, the auditing accuracy of the loan information can be improved, so that a credit platform can make a correct credit decision and the credit risk of the credit platform can be further reduced. In addition, compared with the traditional auditing way, the auditing of the loan information by the reaction time duration is more accurate and faster, and the auditing efficiency is greatly improved.

### BRIEF DESCRIPTION OF THE DRAWINGS

In order to illustrate the technical schemes of embodiments of the present disclosure more clearly, the drawings which need to be used for the embodiments will be briefly introduced below. It should be understood that the following drawings only illustrate some embodiments of the present disclosure, and thus should not be regarded as a limitation on the scope. For those of ordinary skill in the art, other relevant drawings may also be obtained according to the drawings without creative labor.

FIG. 1 is a block schematic diagram of an electronic device provided by an embodiment of the present disclosure.

FIG. 2 is a schematic flowchart of an information auditing method provided by an embodiment of the present disclosure.

FIG. 3 is another schematic flowchart of the information auditing method provided by an embodiment of the present disclosure.

FIG. 4 is a block diagram of functional modules of an information auditing device provided by an embodiment of the present disclosure.

In the drawings: 100—electronic device; 110—memory; 120—processor; 130—detection unit; 200—credit auditing device; 300—voice loan system; 210—recording module; 220—first auditing module; 230—first processing module; 240—second auditing module; 250—second processing module; 260—third processing module; 261—prompting submodule; 262—receiving submodule.

### DETAILED DESCRIPTION OF THE EMBODIMENTS

In order to enable the objects, the technical schemes and the advantages of the embodiments of the present disclosure to become clearer, the technical schemes in the embodiments of the present disclosure will be clearly and completely described below with reference to the accompanying drawings in the embodiments of the present disclosure. Obviously, the described embodiments are only one part of the embodiments of the present disclosure rather than all of the embodiments. In general, the components in the embodiments of the present disclosure described and illustrated in the drawings may be arranged and designed in various different configurations. Therefore, the following detailed description of the embodiments of the present disclosure provided in the drawings does not aim at limiting the scope of the claimed disclosure and only represents the selected embodiments of the present disclosure. Based on the embodiments in the present disclosure, all the other embodiments obtained by those of ordinary skill in the art without creative labor are still within the scope of the claimed disclosure.

It should be noted that similar reference numerals and letters indicate similar items in the following drawings, and therefore, once an item is defined in one drawing, it is not required to be further defined and explained in the subsequent drawings.

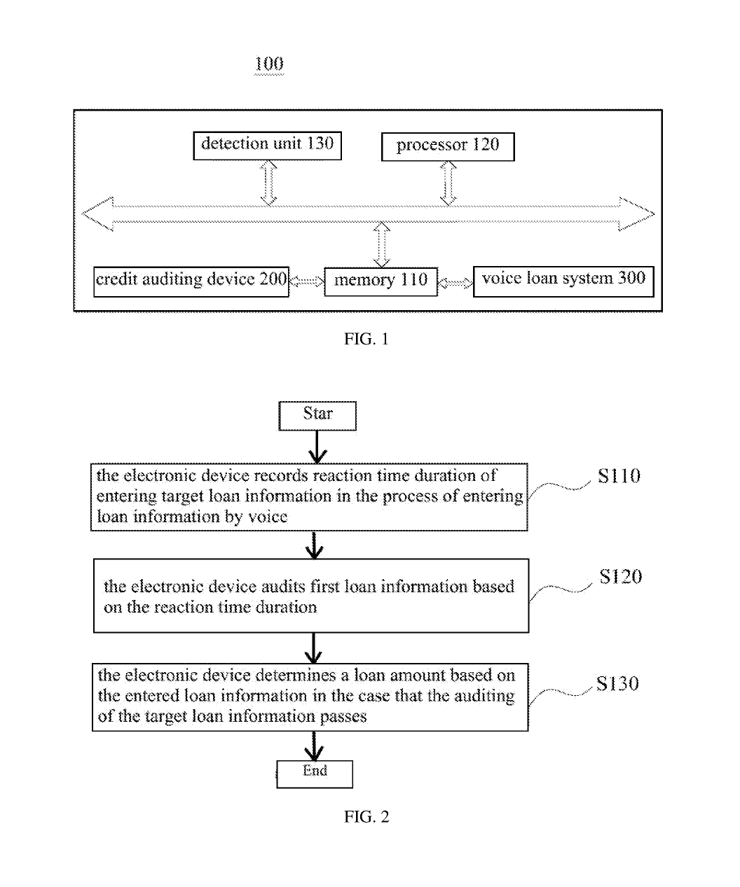

As shown in FIG. 1 which is a block schematic diagram of an electronic device 100 provided by an embodiment of the present disclosure, the electronic device 100 may be a server and may also be a smart terminal (such as a mobile phone, a computer and the like), which is not limited in this embodiment.

The electronic device 100 comprises a memory 110, a processor 120 and a detection unit 130. Various elements of the memory 110, the processor 120 and the detection unit 130 are mutually directly or indirectly electrically connected to realize data transmission or interaction. For example, these elements may be directly electrically connected through one or more communication buses (or signal lines). An information auditing device 200 and a voice loan system 300 are installed in the memory 110. Wherein, the information auditing device 200 may be a subprogram of the voice loan system 300, and may also be a program independent of the voice loan system 300. The voice loan system 300 is used for inputting loan information of a user in a voice way, determining whether a loan request of the user passes or not based on the loan information and further determining a loan amount of the user based on the loan information in the case that the loan request of the user passes.

In addition, the information auditing device 200 and the voice loan system 300 may also be solidified in an operating system (OS) of the electronic device 100, and this is not limited in this embodiment.

In this embodiment, the memory 110 may be, but not limited to, a random access memory (RAM), a read only memory (ROM), a programmable read-only memory (PROM), an erasable programmable read-only memory (EPROM), an electric erasable programmable read-only memory (EEPROM) and the like. The processor 120 may be an integrated circuit chip with a signal processing capability. The processor may be a general-purpose processor, including a central processing unit (CPU), a network processor (NP) and the like; and may also be a digital signal processor (DSP), an application specific integrated circuit (ASIC), a field programmable gate array (FPGA) or other programmable logic devices, a discrete gate or transistor logic device and a discrete hardware component. The various methods, steps and logic block diagrams disclosed in the embodiments of the present disclosure may be implemented or executed. The general-purpose processor may be a microprocessor or the processor may also be any conventional processor and the like.

The detection unit 130 may be an audio sensor, such as a microphone, and the detection unit 130 is used for detecting or collecting sound signals in an environment where the electronic device 100 is located.

It should be understood that the structure shown in FIG. 1 is merely illustrative, and the electronic device 100 may further include more or less components than those shown in FIG. 1, or have a different configuration from that shown in FIG. 1. In addition, the various components included in the electronic device 100 may be implemented by hardware, software or the combination thereof.

As shown in FIG. 2, FIG. 2 is a schematic flowchart of an information auditing method provided by an embodiment of the present disclosure. The information auditing method is applied to the voice loan system 300 shown in FIG. 1, and the voice loan system 300 enters loan information in a voice way. The information auditing method will be described in detail in conjunction with the specific flow shown in FIG. 1.

S110, in the process of entering loan information by voice, the electronic device 100 records reaction time duration of entering target loan information.

In this embodiment, when the voice loan system 300 in the electronic device 100 receives the loan request issued by the user, the voice loan system 300 can output a plurality of prompt voices prompting the user to input various types of loan information, and the user can enter the corresponding loan information based on the various prompt voices. In the process of entering the loan information by the user through the voice loan system 300, the electronic device 100 can record the reaction time duration of entering the target loan information by the user.

The reaction time duration of entering the target loan information refers to a time interval from the completion time of voice broadcast for promoting the user to enter the target loan information to the beginning time of entering the target loan information by the user.

Wherein, the target loan information is at least one piece of the entered loan information, namely the number of pieces of the target loan information can be one, two or more.

Further, the target loan information may be preset, for example, it may be issues which cannot easily verify the authenticity in traditional ways in the entered loan information (such as income, company, company address, home address and the like), and, for example, it may be the issues with a relatively high degree of importance in the entered loan information (such as income, contact information, credit information and the like); and in addition, the target loan information may also be at least one piece which is randomly selected from the entered loan information, which is not limited in this disclosed embodiment.

S120, the electronic device 100 audits the target loan information based on the reaction time duration.

In the practical applications, although the authenticity of the loan information can be determined to a certain extent by an external database or the loan information itself, the accuracy is limited. It is found by researches of disclosers that, if the loan information is entered in the voice way, it is convenient for the user to enter the loan information (especially for the blind or driving people) and can further verify the authenticity of the loan information.

Usually, if the information input by the user is real information, the reaction time duration may be controlled within a certain range. If the information input by the user is false information, the reaction time duration before input may be relatively long, which is generally longer than that of the user inputting the real information. According to this principle, the target loan information can be audited on the basis of the reaction time duration of entering the target loan information by the user. Optionally, in this embodiment, the step S120 may be implemented through the following steps:

judging whether the reaction time duration meets a preset reaction time duration condition or not; and if the preset reaction time duration condition is met, determining that the auditing of the target loan information passes.

In detail, in this embodiment, the step of judging whether the reaction time duration meets the preset reaction time duration condition or not may be implemented through the following steps:

setting a threshold or a threshold range; and if the reaction time duration does not exceed the threshold or the reaction time duration is within the threshold range, determining that the reaction time duration meets the preset reaction time duration condition.

Wherein, the threshold range may be a number range including the threshold, and the threshold range may be flexibly set according to actual demands. For example, if the threshold obtained by calculation is 2 seconds, the 2 seconds may be directly used as the threshold, and the preset range including the 2 seconds (such as 1.5-3 seconds) may be used as the threshold range.

Optionally, in this embodiment, there are many ways to determine the threshold.

As an implementation way, the reaction time duration of entering each piece of preset loan information may be obtained to obtain a plurality of first time durations, an average value of the plurality of the first time durations is calculated to obtain a first average value, and the first average value is used as the threshold.

Wherein, the preset loan information may be all or part of the loan information except the target loan information in the entered loan information. When the preset loan information is part of the loan information except the target loan information in the entered loan information, this part of the loan information may be the loan information having a greater relevance to the target loan information. For example, when the target loan information includes income, company, company address and home address of the user, the preset loan information may include name, age, loan purpose, loan amount and the like of the user.

As another implementation way, the threshold may also be determined on the basis of the reaction time duration of entering the various types of loan information by the user. In detail, the electronic device 100 may obtain the reaction time duration of entering each piece of loan information by the user to obtain a plurality of second time durations, an average value of the plurality of the second time durations is calculated to obtain a second average value, and the second average value is used as the threshold.

As another implementation way, the threshold may also be co-determined on the basis of the reaction time duration of entering the preset loan information by the user and the reaction time duration of entering each piece of loan information. Specifically, this can be implemented through the following steps:

Obtaining the reaction time duration of entering each piece of preset loan information to obtain a plurality of first time durations, and calculating the average value of the plurality of the first time durations to obtain the first average value; obtaining the reaction time duration of entering each piece of loan information to obtain a plurality of second time durations, and calculating the average value of the plurality of second time durations to obtain the second average value; and determining the threshold based on the first average value and the second average value or directly determining the threshold range based on the first average value and the second average value.

Wherein, determining the threshold based on the first average value and the second average value is implemented through the following way: the average value of the first average value and the second average value may be calculated to obtain the third average value, and the third average value or a third preset range including the third average value is used as the threshold.

Determining the threshold range based on the first average value and the second average value is implemented through the following way: the interval determined by the first average value and the second average value is used as a preset time duration. For example, it is assumed that the first average value is 1 second and the second average value is 3 seconds, then [1, 3] (unit: second) may be used as the threshold range.

In this embodiment, when the reaction time duration of entering the target loan information by the user meets the reaction time duration condition determined through the above way, it can be determined that the auditing of the target loan information passes.

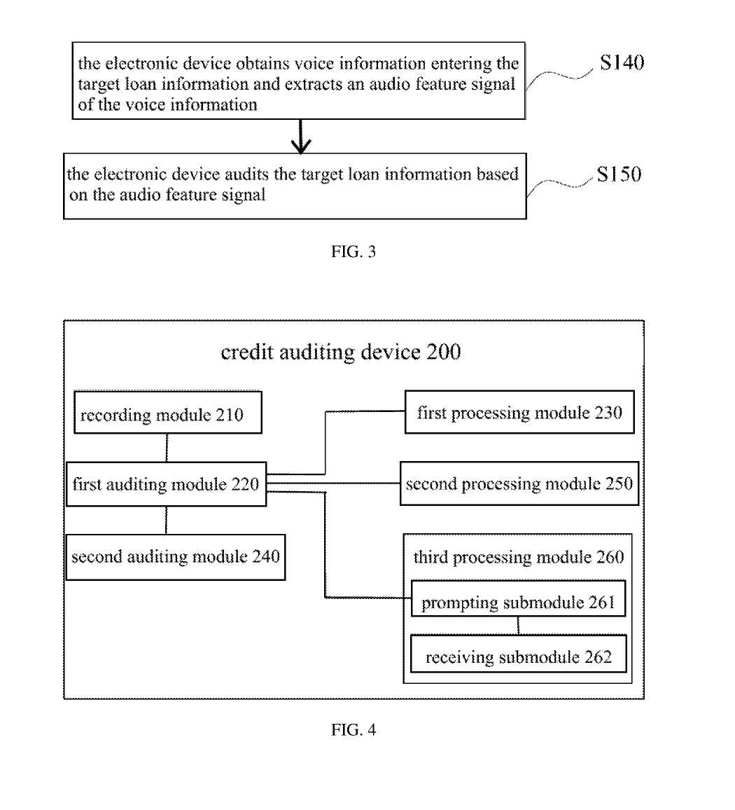

Optionally, as shown in FIG. 3, in this embodiment, the information auditing method may further audit the target loan information through two steps of S140 and S150.

S140, the electronic device 100 obtains voice information entering the target loan information and extracts an audio feature signal of the voice information.

S150, the electronic device 100 audits the target loan information based on the audio feature signal.

As an implementation way, an audio signal feature of the voice information may include a prosodic feature of the voice information (such as, the duration of the signal, the amplitude of the signal, pitch period, formant frequency and the like). During implementation, the type of emotion when the voice information is entered may be identified on the basis of the above audio feature signal, then an emotional state (such as, whether the user is excited or not, whether the user is nervous or not and the like) when the voice information is entered by the user is further determined, and the target loan information is audited according to the identification result.

As another implementation way, the audio signal feature of the voice information may also be a low-frequency signal spectrum based on the voice information. Studies show that physiological tremors in the range of 8-12 Hz are related to muscle contraction of a human body, indicating that psychological stress can have an effect on the body. Therefore, the low-frequency signal spectrum based on the voice information may be analyzed to obtain physiological parameter information when the voice information is entered by the user, and then the psychological stress when the voice information is entered by the user may be further analyzed. When the psychological stress obtained by analysis is larger than the preset threshold, it can be determined that there is falseness in the audited voice information (such as, the target loan information).

As another implementation way, the audio feature signal of the voice information may also be intonation information of the voice information. An expected intonation range of the different loan information may be recorded in the electronic device 100. When implemented, the obtained intonation information of the target loan information may be compared with the expected intonation range of the target loan information, if the former exceeds the expected intonation range, it indicates that the mood of the user may fluctuate greatly when the target loan information is entered by the user, and then it is further determined that the auditing of the target loan information fails.

Optionally, in this embodiment, the electronic device 100 may also audit the target loan information based on the reaction time duration of entering the target loan information, and in the case that the auditing passes, credit risk assessment is performed on the loan request of the user based on the various types of loan information entered by the user.

S130, in the case that the auditing of the target loan information passes, the electronic device 100 determines a loan amount based on the entered loan information.

In this embodiment, different processing may be adopted against the auditing result of the target loan information. In the case that the auditing of the target loan information passes, the processing of S130 is performed.

It should be noted that the “the auditing of the target loan information passes” here includes the following situations: the target loan information has multiple pieces, and the auditing of each of the multiple pieces of the target loan information passes. In this way, when the auditing of the target loan information passes, the voice loan system 300 may perform the credit risk assessment according to a preset risk assessment procedure in the system and further determine the loan amount of the user or directly determine the loan amount based on the entered loan information. Through the above design, the accuracy of credit auditing can be further improved.

Optionally, in this embodiment, against the case that the auditing of the target loan information fails, there may be a variety of processing ways.

For example, in the case that the auditing of first loan information in the target loan information fails, the electronic device 100 may execute at least one of a first operation and a second operation.

The first operation is as follows: outputting first prompt information, wherein the first prompt information is used for prompting to enter verification information corresponding to the first loan information and re-auditing the first loan information based on the verification information after entering the verification information.

Optionally, the verification information corresponding to the first loan information may be the first loan information re-submitted by the user, and may also be other information which is related to the first loan information and can be used for verification, for example, income proof information, company certification information, information of proof of residence and the like.

The second operation is as follows: determining the loan amount based on the entered loan information and reducing the load amount by an amount difference corresponding to the first loan information.

The amount differences corresponding to the different loan information may be recorded in the electronic device 100, and the amount difference corresponding to each piece of loan information can be determined through the relevance of the loan information to credit risk.

In this embodiment, the first loan information is the loan information with a relatively high degree of importance in the target loan information or the loan information which is not easy to verify; and the first loan information may also be all the target loan information which fails in the auditing.

In implementation, the electronic device 100 may determine at least one of the first operation and the second operation to perform according to the degree of importance of each piece of first loan information. In detail, the different first loan information and the operation which should be performed when the auditing of such first loan information fails may be recorded in the electronic device 100. The operation which should be performed when the auditing of the first loan information fails may correspond to the degree of importance of the first loan information. For example, when the first loan information which fails in auditing is income information, the above first operation may be performed in view of the degree of importance of the income information, so that the verification information (such as, income proof information and the like) corresponding to the income information may be entered by the user and the income information may be further audited according to the verification information entered by the user.

In addition, in the case that the auditing of the first loan information in the target loan information fails, the electronic device 100 may execute at least one of the following operations:

further auditing the first loan information in an offline way; and

determining that the loan request of the user fails and no loan is granted.

For another example, in the case that the auditing of second loan information in the target loan information fails, the electronic device 100 may execute the following steps:

outputting second prompt information, wherein the second prompt information is used for prompting to re-enter the second loan information; and

receiving third loan information entered on the basis of the second prompt information and executing at least one of a third operation and a fourth operation.

Wherein, the third operation is as follows: judging whether the second loan information is consistent with the third loan information or not, and if so, determining that the auditing of the second loan information passes.

In this embodiment, the second loan information and the third loan information are the information entered at different time based on the same loan information.

The fourth operation is as follows: calculating the difference between the reaction time duration of entering the second loan information and the reaction time duration of entering the third loan information, and determining that the auditing of the second loan information passes in the case that the difference is within a preset range.

In this embodiment, the preset range can be determined according to the statistical result of big data.

In implementation, against the second loan information and the third loan information, the electronic device 100 may audit the second loan information through the third operation or the fourth operation, and may also audit the second loan information through the third operation and the fourth operation at the same time, and this is not limited in this embodiment.

It should be noted that, in this embodiment, the second loan information may be the same as the first loan information, or may be different from the first loan information. For example, the second loan information may be the loan information which is suitable for auditing by multiple collections.

Optionally, in this embodiment, the first loan information and the second loan information may be flexibly set according to the demands of a credit platform. There are a variety of setting ways. Taking the first loan information as an example, the auditing result of the first loan information can be set to fail by default. In this way, after the target loan information is first audited, the user may be prompted to re-enter the first loan information. For another example, the first loan information in the target loan information may be tagged for identification. If there is the loan information that fails in auditing in the target loan information, whether the loan information is tagged or not is detected, and if so, it is judged that the loan information that fails in auditing is the first loan information, and the corresponding processing way is adopted to further audit the first loan information.

The second loan information may also be set in the same way and will not be repeated redundantly herein.

Through the above design, on the basis of traditional credit auditing, the authenticity of the loan information entered by the user may be further judged based on the hesitation of the loan information entered by the user, thereby improving the accuracy of the credit auditing and reducing the credit risk of the credit platform. In addition, compared with the traditional auditing way, the auditing of the loan information by the reaction time duration is more accurate and faster, and the auditing efficiency is greatly improved.

As shown in FIG. 4, an embodiment of the present disclosure further provides an information auditing device 200. The information auditing device 200 is applied to the voice loan system 300 shown in FIG. 1, and the voice loan system 300 enters loan information in a voice way. The information auditing device 200 comprises a recording module 210, a first auditing module 220 and a first processing module 230.

Wherein, the recording module 210 is used for recording reaction time duration of entering target loan information in the process of entering the loan information by voice, wherein the reaction time duration refers to a time interval from the completion of voice broadcast for promoting to enter the target loan information to the beginning of entering the target loan information.

In this embodiment, the description about the recording module 210 may refer to the detailed description of S110 in FIG. 2, namely the step S110 may be performed by the recording module 210.

The first auditing module 220 is used for auditing the target loan information based on the reaction time duration.

In this embodiment, the description about the first auditing module 220 may refer to the detailed description of S120 in FIG. 2, namely the step S120 may be performed by the first auditing module 220.

Optionally, in this embodiment, the specific way that the first auditing module 220 audits the target loan information based on the reaction time duration is as follows:

judging whether the reaction time duration meets a preset reaction time duration condition or not; and

if the preset reaction time duration condition is met, determining that the auditing of the target loan information passes.

The first processing module 230 is used for determining a loan amount based on the entered loan information in the case that the auditing of the target loan information passes.

In this embodiment, the description about the first processing module 230 may refer to the detailed description of S130 in FIG. 2, namely the step S130 may be performed by the first processing module 230.

Optionally, the information auditing device 200 may also include a second auditing module 240.

The second auditing module 240 is used for obtaining voice information entering the target loan information, extracting an audio feature signal of the voice information and auditing the target loan information based on the audio feature signal.

In this embodiment, the description about the second auditing module 240 may refer to the detailed description of S140 in the above content, namely the step S140 may be performed by the second auditing module 240.

Optionally, the information auditing device 200 may also include a second processing module 250.

The second processing module 250 is used for executing at least one of the following operations in the case that the auditing of first loan information in the target loan information fails:

outputting first prompt information, wherein the first prompt information is used for prompting to enter verification information corresponding to the first loan information and re-auditing the first loan information based on the verification information after entering the verification information; and

determining the loan amount based on the entered loan information and reducing the load amount by an amount difference corresponding to the first loan information.

In this embodiment, the description about the second processing module 250 may refer to the detailed description of S150, namely the step S150 may be performed by the second processing module 250.

Optionally, the information auditing device 200 may also include a third processing module 260.

Wherein, the third processing module 260 may include a prompting submodule 261 and a receiving submodule 262.

The prompting submodule 261 is used for outputting second prompt information in the case that the auditing of the second loan information in the target loan information fails, wherein the second prompt information is used for prompting to re-enter the second loan information.

The receiving submodule 262 is used for receiving third loan information entered on the basis of the second prompt information and executing at least one of the following operations:

judging whether the second loan information is consistent with the third loan information or not, and if so, determining that the auditing of the second loan information passes; and

calculating the difference between the reaction time duration of entering the second loan information and the reaction time duration of entering the third loan information, and determining that the auditing of the second loan information passes in the case that the difference is within a preset range.

In this embodiment, the description about the third processing module 260 may refer to the detailed description of related steps in the above content.

It should be noted that, in this embodiment, the first processing module 230, the second processing module 250, and the third processing module 260 may be performed after the first auditing module 220 is performed, and may also be performed after the first auditing module 220 and the second auditing module 240 are performed, and this is not limited in the embodiment of the present disclosure.

An embodiment of the present disclosure further discloses a computer readable storage medium with a computer program stored thereon, and the computer program implements an information auditing method disclosed by an embodiment of the present disclosure when being executed by the processor 120.

In sum, the information auditing method and device provided by the embodiments of the present disclosure are applied to the voice loan system 300. The electronic device 100 audits the target loan information according to the reaction time duration of entering the target loan information by the user in the voice loan system to determine the credibility of the target loan information. In the case that the auditing of the target loan information passes, a loan amount is further determined on the basis on the entered loan information. In this way, the auditing accuracy of the loan information can be improved, so that a credit platform can make a correct credit decision and the credit risk of the credit platform can be further reduced. In addition, compared with the traditional auditing way, the auditing of the loan information by the reaction time duration is more accurate and faster, and the auditing efficiency is greatly improved.

In the several embodiments provided by the present application, it should be understood that the disclosed device and method may be implemented in other ways. The embodiments of the device described above are merely illustrative, for example, the flowcharts and the block diagrams in the drawings illustrate system architectures, functions and operations which may be implemented by the device, the method and the computer program product in multiple embodiments of the present disclosure. In this regard, each block in the flowcharts or the block diagrams can represent a module, a program segment and one part of codes, and the module, the program segment or one part of the codes contains one or more executable instructions for implementing specified logic functions. It should also be noted that, in some alternative implementation ways, the functions noted in the blocks may also occur in an order which is different from those illustrated in the drawings. For example, two consecutive blocks may be executed substantially in parallel, and they may sometimes be executed in a reverse order, depending upon the functionality involved. It is also noted that each block in the block diagrams and/or the flowcharts and the combinations of the blocks in the block diagrams and/or the flowcharts may be implemented by a dedicated hardware-based system that performs the specified functions or actions, or may be implemented by the combination of dedicated hardware and computer instructions.

In addition, the various functional modules in the various embodiments of the present invention may be integrated into an independent part, or the various modules may exist independently, or two or more modules may be integrated into an independent part.

When the functions are implemented in the form of a software functional module and sold or used as an independent product, the functions may be stored in a computer readable storage medium. Based on such understanding, the portion of the technical schemes of the present disclosure that contributes in essence or to the prior art or the portion of the technical schemes may be implemented in the form of a program product, the computer program product is stored in a storage medium, including a number of instructions for enabling a computer device (which may be a personal computer, a server, a network device or the like) to perform all or part of the steps of the methods described in the various embodiments of the present disclosure. The foregoing storage media includes: a U disk, a mobile hard disk, a read-only memory (ROM), a random access memory (RAM), a magnetic disk, or an optical disk, and various media which may store program codes.

It should be noted that, in this context, relational terms such as first, second and the like are merely used to distinguish one entity or operation from another entity or operation, and do not necessarily require or imply that there is any such actual relation or order between these entities or operations. Furthermore, the terms “comprise”, “comprising” or “contain” or any other variations thereof are intended to encompass a non-exclusive inclusion, such that a process, method, item, or device that comprises a plurality of elements includes not only those elements but also other elements which are not listed clearly, or also includes the elements which are inherent to such process, method, item or device. Without more limitations, the element that is defined by the phrase “comprising a . . . ” does not exclude the presence of additional equivalent elements in the process, method, item, or device that comprises the element.

The above description is only for the embodiments of the present disclosure, and is not intended to limit the present disclosure, and various changes and modifications may be made by those of skill in the art to the present disclosure. Any modifications, equivalent substitutions, improvements and the like made within the spirit and principle of the present disclosure are intended to be included within the scope of the present disclosure.

### INDUSTRIAL APPLICABILITY

The information auditing method provided by the present disclosure audits the target loan information according to the reaction time duration of entering the target loan information to determine the credibility of the target loan information. In this way, the accuracy of the loan auditing can be improved, so that the credit platform can make a correct credit decision and the credit risk of the credit platform can be further reduced.

1. An information auditing method, characterized in that, the information auditing method is applied to a voice loan system, the voice loan system enters loan information in a voice way, and the method comprises: in the process of entering the loan information by voice, recording reaction time duration of entering target loan information, wherein the reaction time duration refers to a time interval from the completion of voice broadcast for promoting to enter the target loan information to the beginning of entering the target loan information; auditing the target loan information based on the reaction time duration; and determining a loan amount based on the entered loan information in the case that the auditing of the target loan information passes.

2. The method according to claim 1, characterized in that, the auditing of the target loan information based on the reaction time duration comprises: judging whether the reaction time duration meets a preset reaction time duration condition or not; and if the preset reaction time duration condition is met, determining that the auditing of the target loan information passes.

3. The method according to claim 2, characterized in that, the preset reaction time duration condition is a preset threshold or a preset threshold range,
the step of determining that the auditing of the target loan information passes if the preset reaction time duration condition is met comprises:
if the reaction time duration does not exceed the preset threshold or the reaction time duration is within the preset threshold range, determining that the auditing of the target loan information passes.

4. The method according to claim 1, characterized in that, the method further comprises: in the case that the auditing of first loan information in the target loan information fails, executing at least one of the following operations: outputting first prompt information, wherein the first prompt information is used for prompting to enter verification information corresponding to the first loan information and re-auditing the first loan information based on the verification information after entering the verification information; and determining the loan amount based on the entered loan information, and reducing the load amount by an amount difference corresponding to the first loan information.

5. The method according to claim 1, characterized in that, in the case that the auditing of second loan information in the target loan information fails, the method further comprises: outputting second prompt information, wherein the second prompt information is used for prompting to re-enter the second loan information; receiving third loan information entered on the basis of the second prompt information and executing at least one of the following operations: judging whether the second loan information is consistent with the third loan information or not, and if so, determining that the auditing of the second loan information passes; calculating the difference between the reaction time duration of entering the second loan information and the reaction time duration of entering the third loan information, and determining that the auditing of the second loan information passes in the case that the difference is within a preset range.

6. The method according to claim 1, characterized in that, the method further comprises: obtaining voice information entering the target loan information and extracting an audio feature signal of the voice information; and auditing the target loan information based on the audio feature signal.

7. The method according to claim 2, characterized in that, the method further comprises: in the case that the auditing of first loan information in the target loan information fails, executing at least one of the following operations: outputting first prompt information, wherein the first prompt information is used for prompting to enter verification information corresponding to the first loan information and re-auditing the first loan information based on the verification information after entering the verification information; and determining the loan amount based on the entered loan information, and reducing the load amount by an amount difference corresponding to the first loan information.

8. The method according to claim 6, characterized in that, the step of auditing the target loan information based on the audio feature signal comprises:
analyzing the obtained audio feature signal to obtain a low-frequency signal spectrum based on the voice information;
obtaining a psychological parameter when a user enters the voice information according to the low-frequency signal spectrum based on the voice information; and
auditing the target loan information according to the psychological parameter.

9. The method according to claim 2, characterized in that, in the case that the auditing of second loan information in the target loan information fails, the method further comprises: outputting second prompt information, wherein the second prompt information is used for prompting to re-enter the second loan information; receiving third loan information entered on the basis of the second prompt information and executing at least one of the following operations: judging whether the second loan information is consistent with the third loan information or not, and if so, determining that the auditing of the second loan information passes; calculating the difference between the reaction time duration of entering the second loan information and the reaction time duration of entering the third loan information, and determining that the auditing of the second loan information passes in the case that the difference is within a preset range.

10. An information auditing device, characterized in that, the information auditing device is applied to a voice loan system, the voice loan system enters loan information in a voice way, and the device comprises: a recording module configured to record reaction time duration of entering target loan information in the process of entering the loan information by voice, wherein the reaction time duration refers to a time interval from the completion of voice broadcast for promoting to enter the target loan information to the beginning of entering the target loan information; a first auditing module configured to audit the target loan information based on the reaction time duration; and a first processing module configured to determine a loan amount based on the entered loan information in the case that the auditing of the target loan information passes.

11. An electronic device, characterized in that, the electronic device comprises a memory and a processor, the memory is configured to store computer program codes, and the processor is configured to execute the computer program codes stored in the memory to implement the following operations:
in the process of entering the loan information by voice, recording reaction time duration of entering target loan information, wherein the reaction time duration refers to a time interval from the completion of voice broadcast for promoting to enter the target loan information to the beginning of entering the target loan information;
auditing the target loan information based on the reaction time duration; and
determining a loan amount based on the entered loan information in the case that the auditing of the target loan information passes.

12. The electronic device according to claim 11, characterized in that, the specific way of auditing the target loan information based on the reaction time duration by the processor is as follows:
judging whether the reaction time duration meets a preset reaction time duration condition or not; and if the preset reaction time duration condition is met, determining that the auditing of the target loan information passes.

13. The electronic device according to claim 12, characterized in that, the preset reaction time duration condition is a preset threshold or a preset threshold range, the step of determination made by the processor that the auditing of the target loan information passes if the preset reaction time duration condition is met comprises:
if the reaction time duration does not exceed the preset threshold or the reaction time duration is within the preset threshold range, determining that the auditing of the target loan information passes.

14. The electronic device according to claim 11, characterized in that, in the case that the auditing of first loan information in the target loan information fails, the processor is configured to execute the computer program codes stored in the memory to implement at least one of the following operations: outputting first prompt information, wherein the first prompt information is used for prompting to enter verification information corresponding to the first loan information and re-auditing the first loan information based on the verification information after entering the verification information; and determining the loan amount based on the entered loan information, and reducing the load amount by an amount difference corresponding to the first loan information.

15. The electronic device according to claim 11, characterized in that, the processor is configured to execute the computer program codes stored in the memory to implement the following operations:
in the case that the auditing of second loan information in the target loan information fails, outputting second prompt information, wherein the second prompt information is used for prompting to re-enter the second loan information; receiving third loan information entered on the basis of the second prompt information and executing at least one of the following operations: judging whether the second loan information is consistent with the third loan information or not, and if so, determining that the auditing of the second loan information passes; calculating the difference between the reaction time duration of entering the second loan information and the reaction time duration of entering the third loan information, and determining that the auditing of the second loan information passes in the case that the difference is within a preset range.

16. The electronic device according to claim 11, characterized in that, the processor is configured to execute the computer program codes stored in the memory to implement the following operations:
obtaining voice information entering the target loan information and extracting an audio feature signal of the voice information; and auditing the target loan information based on the audio feature signal.

17. The electronic device according to claim 12, characterized in that, in the case that the auditing of first loan information in the target loan information fails, the processor is configured to execute the computer program codes stored in the memory to implement at least one of the following operations: outputting first prompt information, wherein the first prompt information is used for prompting to enter verification information corresponding to the first loan information and re-auditing the first loan information based on the verification information after entering the verification information; and determining the loan amount based on the entered loan information, and reducing the load amount by an amount difference corresponding to the first loan information.

18. The electronic device according to claim 16, characterized in that, the specific way of auditing the target loan information by the processor based on the audio feature signal comprises: analyzing the obtained audio feature signal to obtain a low-frequency signal spectrum based on the voice information;
obtaining a psychological parameter when a user enters the voice information according to the low-frequency signal spectrum based on the voice information; and
auditing the target loan information according to the psychological parameter.

19. The electronic device according to claim 12, characterized in that, the processor is configured to execute the computer program codes stored in the memory to implement the following operations:
in the case that the auditing of second loan information in the target loan information fails, outputting second prompt information, wherein the second prompt information is used for prompting to re-enter the second loan information; receiving third loan information entered on the basis of the second prompt information and executing at least one of the following operations: judging whether the second loan information is consistent with the third loan information or not, and if so, determining that the auditing of the second loan information passes; calculating the difference between the reaction time duration of entering the second loan information and the reaction time duration of entering the third loan information, and determining that the auditing of the second loan information passes in the case that the difference is within a preset range.

20. A computer readable storage medium having a computer program stored thereon, characterized in that, the computer program implements the following operations when being executed by the processor:
in the process of entering the loan information by voice, recording reaction time duration of entering target loan information, wherein the reaction time duration refers to a time interval from the completion of voice broadcast for promoting to enter the target loan information to the beginning of entering the target loan information;
auditing the target loan information based on the reaction time duration; and
determining a loan amount based on the entered loan information in the case that the auditing of the target loan information passes.

21. The computer readable storage medium according to claim 20, characterized in that, the specific way of auditing the target loan information based on the reaction time duration by the processor is as follows:
judging whether the reaction time duration meets a preset reaction time duration condition or not; and if the preset reaction time duration condition is met, determining that the auditing of the target loan information passes.

22. The computer readable storage medium according to claim 21, characterized in that, the preset reaction time duration condition is a preset threshold or a preset threshold range,
the step of determination made by the processor that the auditing of the target loan information passes if the preset reaction time duration condition is met comprises:
if the reaction time duration does not exceed the preset threshold or the reaction time duration is within the preset threshold range, determining that the auditing of the target loan information passes.

23. The computer readable storage medium according to claim 20, characterized in that, in the case that the auditing of first loan information in the target loan information fails, the computer program is also applied to implement at least one of the following operations when being executed by the processor:
outputting first prompt information, wherein the first prompt information is used for prompting to enter verification information corresponding to the first loan information and re-auditing the first loan information based on the verification information after entering the verification information; and determining the loan amount based on the entered loan information, and reducing the load amount by an amount difference corresponding to the first loan information.

24. The computer readable storage medium according to claim 20, characterized in that, the computer program is also applied to implement the following operations when being executed by the processor:
in the case that the auditing of second loan information in the target loan information fails, outputting second prompt information, wherein the second prompt information is used for prompting to re-enter the second loan information; receiving third loan information entered on the basis of the second prompt information and executing at least one of the following operations: judging whether the second loan information is consistent with the third loan information or not, and if so, determining that the auditing of the second loan information passes; calculating the difference between the reaction time duration of entering the second loan information and the reaction time duration of entering the third loan information, and determining that the auditing of the second loan information passes in the case that the difference is within a preset range.

25. The computer readable storage medium according to claim 20, characterized in that, the computer program is also applied to implement the following operations when being executed by the processor:
obtaining voice information entering the target loan information and extracting an audio feature signal of the voice information; and auditing the target loan information based on the audio feature signal.

26. The computer readable storage medium according to claim 21, characterized in that, in the case that the auditing of first loan information in the target loan information fails, the computer program is also applied to implement at least one of the following operations when being executed by the processor:
outputting first prompt information, wherein the first prompt information is used for prompting to enter verification information corresponding to the first loan information and re-auditing the first loan information based on the verification information after entering the verification information; and determining the loan amount based on the entered loan information, and reducing the load amount by an amount difference corresponding to the first loan information.

27. The computer readable storage medium according to claim 25, characterized in that,
analyzing the obtained audio feature signal to obtain a low-frequency signal spectrum based on the voice information;
obtaining a psychological parameter when a user enters the voice information according to the low-frequency signal spectrum based on the voice information; and
auditing the target loan information according to the psychological parameter.

28. The computer readable storage medium according to claim 21, characterized in that, the computer program is also applied to implement the following operations when being executed by the processor:
in the case that the auditing of second loan information in the target loan information fails, outputting second prompt information, wherein the second prompt information is used for prompting to re-enter the second loan information; receiving third loan information entered on the basis of the second prompt information and executing at least one of the following operations: judging whether the second loan information is consistent with the third loan information or not, and if so, determining that the auditing of the second loan information passes; calculating the difference between the reaction time duration of entering the second loan information and the reaction time duration of entering the third loan information, and determining that the auditing of the second loan information passes in the case that the difference is within a preset range.
